(19) United States
(12) Patent Application Publication
(10) Pub. No.: US 2019/0058758 A1
(43) Pub. Date: Feb. 21, 2019

(54) Method and Device for Managing Heterogeneous Distributed Cloud Resources, Apparatus, and Computer-Readable Storage Medium

(71) Applicant: BOE TECHNOLOGY GROUP CO., LTD., Beijing (CN)

(72) Inventor: Yong JIANG, Beijing (CN)

(21) Appl. No.: 16/023,391

(22) Filed: Jun. 29, 2018

(30) Foreign Application Priority Data
Aug. 21, 2017 (CN) 201710718755.9

(51) Int. Cl. H04L 29/08; G06Q 30/06

(52) U.S. Cl. CPC H04L 67/10; G06Q 30/0635; H04L 67/16

(57) ABSTRACT

A method and a device for managing heterogeneous distributed cloud resources, an apparatus, and a computer-readable storage medium are provided. The method for managing heterogeneous distributed cloud resources, comprising: accessing the heterogeneous distributed cloud resources; creating a correspondence between cloud products and the heterogeneous distributed cloud resources, and publishing information of the cloud products; receiving an order of a user for a cloud product; determining heterogeneous distributed cloud resources corresponding to the cloud product ordered by the user according to the order of the user by using the correspondence between the cloud products and the heterogeneous distributed cloud resources; and accessing the determined heterogeneous distributed cloud resources corresponding to the cloud product ordered by the user, and creating the cloud product ordered by the user.

### CROSS-REFERENCE TO RELATED APPLICATION

The present disclosure claims priority to the Chinese patent application No. 201710718755.9, filed on Aug. 21, 2017, the entire contents of which are incorporated herein by reference.

### TECHNICAL FIELD

The present disclosure relates to the technical field of cloud computing, in particular to a method for managing heterogeneous distributed cloud resources, a device for managing heterogeneous distributed cloud resources, an apparatus, and a computer-readable storage medium.

### BACKGROUND

Cloud platform is a platform tool for dealing with the problem of managing a plurality of cloud resources in a new hybrid cloud at cloud era, and the cloud platform can take full advantage of characteristics of the cloud computing and significantly increase productivity.

After adopting a cloud, in particular the hybrid cloud, an enterprise generally lacks a management of resource pools of the hybrid cloud or the plurality of clouds, and thus needs of the enterprise managing the cloud resources and using the cloud resources efficiently cannot be meet. For example, an enterprise often uses the hybrid cloud or a plurality of private clouds to meet requirements on cost, demand, and the like. Therefore infrastructure resource pools are diversified and decentralized, and include a physical machine, a virtualized environment, a private cloud, a public cloud, and the like. A cloud product is distributed in a plurality of heterogeneous or homogenous resource pools. Some cloud products need to be migrated in a heterogeneous environment, some cloud products need to be deployed in a plurality of heterogeneous resource pools, and some cloud products even need to run and extend cross-cloud and cross-network. Management of the cloud resources have great pressure and workload due to a lack of suitable tools and relying on manual operation.

### SUMMARY

The present disclosure provides a method for managing heterogeneous distributed cloud resources, comprising steps of:

accessing the heterogeneous distributed cloud resources;

creating a correspondence between cloud products and the heterogeneous distributed cloud resources, and publishing information of the cloud products;

receiving an order of a user for a cloud product;

determining heterogeneous distributed cloud resources corresponding to the cloud product ordered by the user according to the order of the user by using the correspondence between the cloud products and the heterogeneous distributed cloud resources; and

accessing the determined heterogeneous distributed cloud resources corresponding to the cloud product ordered by the user, and creating the cloud product ordered by the user.

In some embodiments, the step of publishing information of the cloud products comprises publishing price of the cloud products.

In some embodiments, after the step of receiving an order of a user for a cloud product, the method further comprises a step of:

determining, according to the order of the user, cost of the cloud product ordered by the user and amount of cloud resources occupied by the cloud product ordered by the user.

In some embodiments, the step of accessing the determined heterogeneous distributed cloud resources corresponding to the cloud product ordered by the user and creating the cloud product ordered by the user comprises:

accessing the determined heterogeneous distributed cloud resources corresponding to the cloud product ordered by the user via an application programming interface and creating the cloud product ordered by the user.

In some embodiments, the cloud products comprise:

a cloud hosting service and/or a cloud storage service.

In some embodiments, the heterogeneous distributed cloud resources comprise:

an X86 physical machine and/or a public cloud.

The present disclosure further provides a device for managing heterogeneous distributed cloud resources, comprising:

a resource access portion, which is configured to access the heterogeneous distributed cloud resources;

a product management portion, which is configured to create a correspondence between cloud products and the heterogeneous distributed cloud resources, and publish information of the cloud products;

an order receiving portion, which is configured to receive an order of a user for a cloud product;

a resource determination and deployment portion, which is configured to determine heterogeneous distributed cloud resources corresponding to the cloud product ordered by the user according to the order of the user by using the created correspondence between the cloud products and the heterogeneous distributed cloud resources; and

an automated layout portion, which is configured to access the determined heterogeneous distributed cloud resources corresponding to the cloud product ordered by the user, and create the cloud product ordered by the user.

In some embodiments, the device further comprises:

a metering and billing portion, which is configured to determine, according to the order of the user, cost of the cloud product ordered by the user and amount of cloud resources occupied by the cloud product ordered by the user.

In some embodiments, the automated layout portion is configured to access the determined heterogeneous distributed cloud resources corresponding to the cloud product ordered by the user via an application programming interface and create the cloud product ordered by the user.

In some embodiments, the device further comprises:

a user management portion, which is configured to manage the user in the form of a tenant.

The present disclosure further provides an apparatus, including:

at least one processor; and

a memory, which is configured to store instructions,

wherein when the instructions are executed by the at least one processor, the at least one processor performs the aforementioned method.

The present disclosure further provides a computer-readable storage medium storing instructions, wherein when the instructions are executed by a processor, the processor performs the aforementioned method.

### BRIEF DESCRIPTION OF THE FIGURES

FIG. 1 shows a block diagram of a device for managing heterogeneous distributed cloud resources according to an embodiment of the present disclosure;

FIG. 2 shows a flowchart illustrating a method for managing heterogeneous distributed cloud resources method according to an embodiment of the present disclosure; and

FIG. 3 shows a schematic diagram of an apparatus which performs a method for managing heterogeneous distributed cloud resources according to an embodiment of the present disclosure.

### DETAILED DESCRIPTION

The present disclosure will be described in detail below in conjunction with the drawings in order that a person skilled in the art can understand the technical solutions of the present disclosure better.

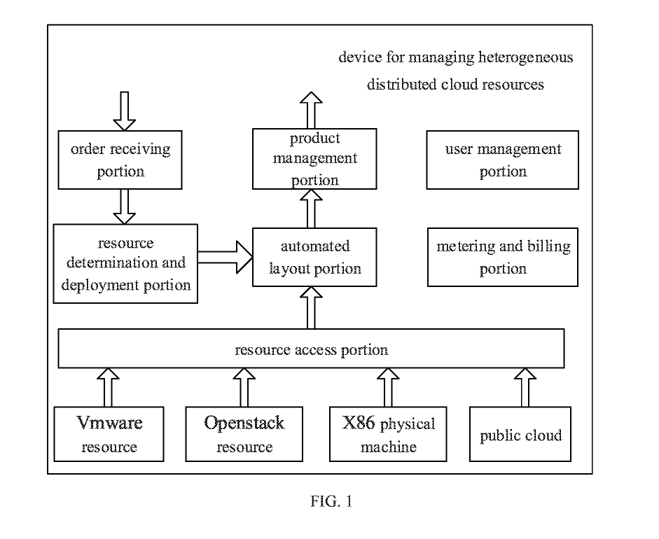

As shown in FIG. 1, the present disclosure provides a device for managing heterogeneous distributed cloud resources, which can uniformly manage various heterogeneous distributed cloud resources and can automatically create various cloud products by using these heterogeneous distributed cloud resources. Thereby cloud resource acquisition rate and business efficiency can be significantly increased when a user purchases or uses a cloud product.

It should be noted that, the heterogeneous distributed cloud resources refer to different kinds of resource pools which are distributed separately, such as a traditional IT physical resource pool, a virtualized resource pool, and a private cloud. In some embodiments, the heterogeneous distributed cloud resources include a VMware resource, an Openstack resource, an X86 physical machine, and a public cloud.

The device for managing heterogeneous distributed cloud resources includes: a resource access portion, a product management portion, a user management portion, a resource determination and deployment portion, and an automated layout portion.

The resource access portion is configured to access the heterogeneous distributed cloud resources.

Specifically, the resource access portion may access the heterogeneous distributed cloud resources via an application programming interface (API) to manage the heterogeneous distributed cloud resources.

The product management portion is configured to create a correspondence between cloud products and heterogeneous distributed cloud resources, and publish information of the cloud products.

In some embodiments, the product management portion is further configured to create a correspondence between the user and the cloud product ordered by the user, and provides the created cloud product to the user corresponding to the created cloud product according to the correspondence. Effective management of the cloud resources and users is achieved by creating these correspondences.

In some embodiments, the device for managing heterogeneous distributed cloud resources further includes a service directory portion, and the user may use the service directory portion to place an order for a cloud product.

In some embodiments, the device for managing heterogeneous distributed cloud resources further includes an order receiving portion which is configured to receive the user's order.

The resource determination and deployment portion is configured to determine heterogeneous distributed cloud resources corresponding to the cloud product ordered by the user according to the user's order by using the created correspondence between cloud products and heterogeneous distributed cloud resources.

The automated layout portion is configured to access the heterogeneous distributed cloud resources determined by the resource determination and deployment portion, and create the cloud product.

In some embodiments, the automated layout portion is in particular configured to access the heterogeneous distributed cloud resources determined by the resource determination and deployment portion via an API, and create the cloud product.

In some embodiments, the device for managing heterogeneous distributed cloud resources further includes a metering and billing portion. The metering and billing portion is configured to determine cost of the cloud product ordered by the user and amount of resources occupied by the cloud product according to the user's order.

Specifically, the metering and billing portion performs real-time monitoring and statistics on the amount of various cloud resources occupied by the cloud product created by the product management portion, thus achieving effective management of the cloud resources. In addition, the user is billed based on the kind and amount of the cloud product ordered by the user.

The device for managing heterogeneous distributed cloud resources further includes a user management portion configured to manage the user in the form of a tenant.

Specifically, in the case that the user has been registered in the device for managing heterogeneous distributed cloud resources, the user management portion adds the user to the user management portion in the form of the tenant and manages the user. It should be noted that, the form of the tenant refers to that in the case that the user has purchased the cloud product, the user can gain access to the cloud product and the cloud resources corresponding to the cloud product. The cloud resources enjoyed by different users are isolated from each other, thereby the security of user data and network can be ensured. In addition, the tenant may have sub-tenants to allocate and manage the cloud resources more granularly.

The device for managing heterogeneous distributed cloud resources in this embodiment can adapt to different kinds of cloud resources. The heterogeneous distributed cloud resources are accessed by the resource access portion in order to be managed uniformly. In the case that the user has ordered the cloud product, the resource determination and deployment portion determines the heterogeneous distributed cloud resources corresponding to the cloud product according to the correspondence, which is created by the product management portion, between cloud products and heterogeneous distributed cloud resources. The automated layout portion accesses the heterogeneous distributed cloud resources determined by the resource determination and deployment portion, and automatically creates the cloud product without manual work. Thereby cloud resource acquisition rate and business efficiency are significantly increased, and the heterogeneous distributed cloud resources are managed uniformly and efficiently.

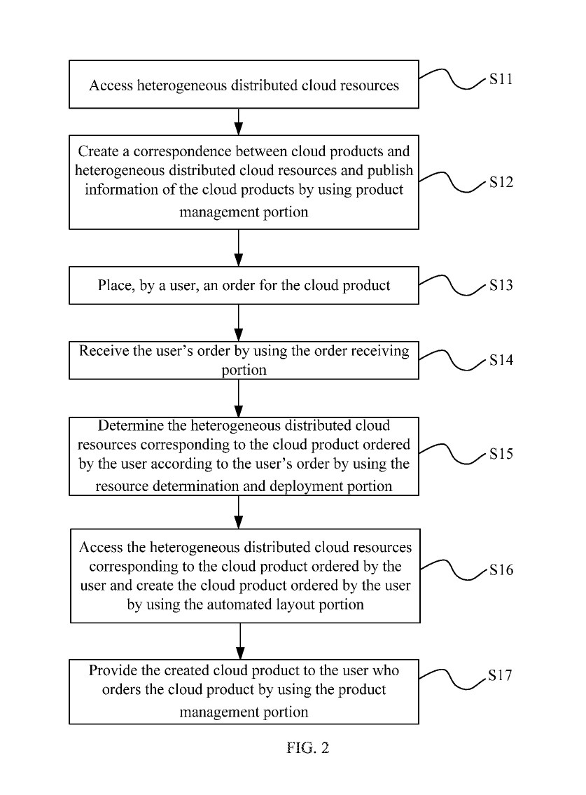

As shown in FIG. 2, the present disclosure provides a method for managing heterogeneous distributed cloud resources. The method for managing heterogeneous distributed cloud resources includes following steps S11 to S17.

In step S11, the heterogeneous distributed cloud resources are accessed to manage the heterogeneous distributed cloud resources.

Specifically, the heterogeneous distributed cloud resources may be accessed via an API.

In step S12, a correspondence between cloud products and heterogeneous distributed cloud resources is created and information of the cloud products is published by the product management portion.

The device for managing heterogeneous distributed cloud resources may create various cloud products based on various cloud resources, and creation of each of the cloud products may require a distinct group of cloud resources. Therefore, in this embodiment, with the correspondence between cloud products and heterogeneous distributed cloud resources, the required cloud resources can be acquired fast to create the cloud product.

In addition, the product management portion publishes the information of each cloud product such that users can purchase necessary cloud products based on the information.

It should be noted that, the information of each cloud product may have been created in advance and be directly available to the user, or be created after the user places an order for the cloud product.

In some embodiments, the cloud products include a cloud hosting service and/or a cloud storage service. The cloud products may further include services such as a cloud network. It should be noted that, the more kinds of cloud products are included, the more kinds of cloud resources are needed to be accessed by the resource access portion.

The information of each cloud product includes information regarding a title, a function and the like of the cloud product from which the user can select a required cloud product. In some embodiments, the information of each cloud product may further include the price of the cloud product and the amount of cloud resources occupied by the cloud product.

In step S13, the user places an order for the cloud product.

Specifically, after the user logs into the device for managing heterogeneous distributed cloud resources, the user may place an order for the required cloud product according to the information of the cloud products published by the product management portion.

In step S14, the user's order is received by the order receiving portion.

Specifically, the user's order is received and confirmed by the order receiving portion in the device for managing heterogeneous distributed cloud resources, such that the cloud product ordered by the user may be determined and the cloud product may be created in a subsequent step.

In step S15, the heterogeneous distributed cloud resources corresponding to the cloud product ordered by the user are determined by the resource determination and deployment portion according to the user's order.

Specifically, the cloud product ordered by the user (i.e., the cloud product to be created) is determined by the resource determination and deployment portion according to the user's order and the cloud resources (i.e., demand information) required to create the cloud product are determined by the resource determination and deployment portion according to the correspondence between cloud products and heterogeneous distributed cloud resources created in step S12, and the demand information is sent to the automated layout portion.

In some embodiments, the demand information is sent to the automated layout portion by the resource determination and deployment portion via an API.

In step S16, the heterogeneous distributed cloud resources determined in step S15 are accessed by the automated layout portion and the cloud product ordered by the user is created by the automated layout portion.

Specifically, the automated layout portion receives the demand information and accesses the cloud resources corresponding to the demand information, such as at least one of a VMware resource, an Openstack resource, an X86 physical machine, and a public cloud. Then, the cloud product is automatically created with the accessed cloud resources for use by the user.

In some embodiments, after the cloud product has been created by the automated layout portion, the information that the creation has been completed is fed back to the product management portion such that the product management portion can timely update the publishing of the cloud product.

In step S17, the created cloud product is provided, by the product management portion, to the user who orders the cloud product.

Specifically, after receiving the user's order, the product management portion creates the correspondence between the user and the cloud product ordered by the user according to the user's order. The correspondence between the user and the cloud product ordered by the user includes the information of the kind and amount of the cloud product ordered by the user, and the information of the amount of various cloud resources occupied by the cloud product ordered by the user. The created cloud product can be accurately provided to the user who orders the cloud product with the creation of the correspondence, such that effective management of cloud resources and users can be achieved.

In the method for managing heterogeneous distributed cloud resources of this embodiment, the heterogeneous distributed cloud resources are accessed by the device for managing heterogeneous distributed cloud resources for unified management. In the case that the user has ordered the cloud product, according to the correspondence, which is created by the product management portion, between cloud products and heterogeneous distributed cloud resources, the cloud resources corresponding to the cloud product are accessed automatically and the cloud product is created automatically without manual work. Thereby, cloud resource acquisition rate and business efficiency are significantly increased, and the heterogeneous distributed cloud resources are managed uniformly and efficiently.

The present disclosure provides an apparatus comprising at least one processor and a memory for storing instructions. When the instructions are executed by the at least one processor, the at least one processor performs the aforementioned method for managing heterogeneous distributed cloud resources.

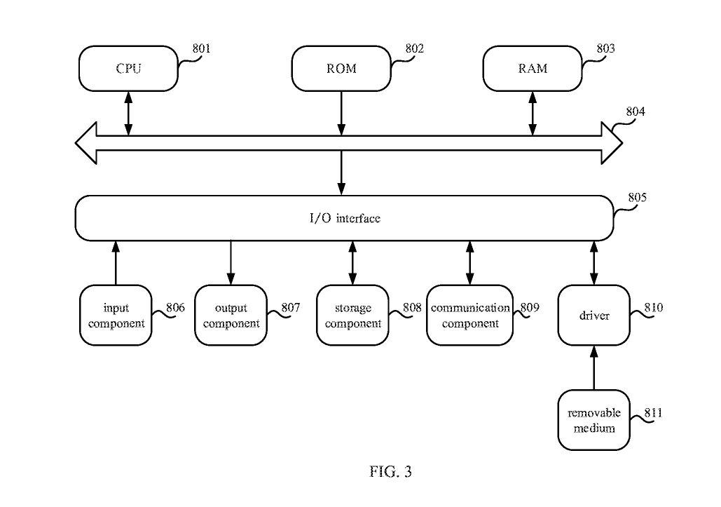

FIG. 3 shows a schematic structural diagram of an apparatus according to an embodiment of the present disclosure. For example, the apparatus may be used to perform method for managing heterogeneous distributed cloud resources provided by the embodiment of the disclosure.

As shown in FIG. 3, the present disclosure further provides an apparatus including at least one central processing component (CPU) 801 that may perform various appropriate actions and processes related to the method for managing heterogeneous distributed cloud resources according to programs stored in a read only memory (ROM) 802 or loaded to a random access memory (RAM) 803 from a storage component 808. In the RAM 803, various programs and data required for an operation of the apparatus shown in FIG. 3 are also stored. CPU 801, ROM 802, and RAM 803 are connected to each other through a bus 804. An input/output (I/O) interface 805 is also connected to the bus 804.

The apparatus further includes following components connected to the I/O interface 805: an input component 806 including a keyboard, a mouse, and the like; an output component 807 including a cathode ray tube (CRT), a liquid crystal display (LCD), a speaker, and the like; an storage component 808 including a hard disk and the like; and a communication component 809 including a network interface card such as a LAN card, a modem, and the like. The communication component 809 performs communication processing via a network such as the Internet. A driver 810 is also connected to the I/O interface 805 as needed. A removable medium 811 such as a magnetic disk, an optical disk, a magneto-optical disk, a semiconductor memory, and the like is mounted on the driver 810 as needed so that a computer program read therefrom can be installed into the storage component 808 as needed.

The present disclosure provides a computer-readable storage medium storing instructions, and the aforementioned method for managing heterogeneous distributed cloud resources is performed when the instructions are executed by a processor.

Flowcharts and block diagrams in the figures illustrate architectures, functionalities, and operations of systems, methods, and computer program products according to various embodiments of the present disclosure which can be performed. In this regard, each block of the flowcharts or block diagrams may represent a portion, a program segment, or a part of code, and the portion, the program segment, or the part of the code includes at least one executable instruction for performing a specified logic function. It should also be noted that, in some alternative implementations, the functions in the blocks may be performed in a different order relative to those in the figures. For example, two blocks represented as a sequential connection may be performed substantially in parallel, and may sometimes be performed in a reverse order according to functions involved. It should also be noted that, each block of the block diagrams and/or flowcharts, and combinations of the blocks can be performed by a special purpose hardware-based system that performs specified functions or operations, or can be performed by a combination of a special purpose hardware and computer instructions.

Components or portions involved in the embodiments of the present disclosure may be performed through software or hardware. The described components or portions may also be provided in a processor. For example, each of the components or portions may be a software program installed in a computer or a mobile smart device, or may be a separately configured hardware device. In some cases, these components or portions are not limited by their title.

It will be appreciated that, the above embodiments are only exemplary embodiments for illustrating the principle of the disclosure, and the present disclosure is not limited thereto. An ordinary person skilled in the art may make various modifications and improvements without departing from the spirit and essence of the present disclosure. These modifications and improvements should be considered as belonging to the protection scope of the present disclosure.

What is claimed is:

1. A method for managing heterogeneous distributed cloud resources, comprising steps of:
accessing the heterogeneous distributed cloud resources;
creating a correspondence between cloud products and the heterogeneous distributed cloud resources, and publishing information of the cloud products;
receiving an order of a user for a cloud product;
determining heterogeneous distributed cloud resources corresponding to the cloud product ordered by the user according to the order of the user by using the correspondence between the cloud products and the heterogeneous distributed cloud resources; and
accessing the determined heterogeneous distributed cloud resources corresponding to the cloud product ordered by the user, and creating the cloud product ordered by the user.

2. The method for managing heterogeneous distributed cloud resources of claim 1, wherein
the step of publishing information of the cloud products comprises publishing price of the cloud products.

3. The method for managing heterogeneous distributed cloud resources of claim 2, wherein after the step of receiving an order of a user for a cloud product, the method further comprises a step of:
determining, according to the order of the user, cost of the cloud product ordered by the user and amount of cloud resources occupied by the cloud product ordered by the user.

4. The method for managing heterogeneous distributed cloud resources of claim 1, wherein the step of accessing the determined heterogeneous distributed cloud resources corresponding to the cloud product ordered by the user and creating the cloud product ordered by the user comprises:
accessing the determined heterogeneous distributed cloud resources corresponding to the cloud product ordered by the user via an application programming interface and creating the cloud product ordered by the user.

5. The method for managing heterogeneous distributed cloud resources of claim 1, wherein the cloud products comprise:
a cloud hosting service and/or a cloud storage service.

6. The method for managing heterogeneous distributed cloud resources of claim 1, wherein the heterogeneous distributed cloud resources comprise:
an X86 physical machine and/or a public cloud.

7. A device for managing heterogeneous distributed cloud resources, comprising:
a resource access portion, which is configured to access the heterogeneous distributed cloud resources;
a product management portion, which is configured to create a correspondence between cloud products and the heterogeneous distributed cloud resources, and publish information of the cloud products;
an order receiving portion, which is configured to receive an order of a user for a cloud product;
a resource determination and deployment portion, which is configured to determine heterogeneous distributed cloud resources corresponding to the cloud product ordered by the user according to the order of the user by using the created correspondence between the cloud products and the heterogeneous distributed cloud resources; and
an automated layout portion, which is configured to access the determined heterogeneous distributed cloud resources corresponding to the cloud product ordered by the user, and create the cloud product ordered by the user.

8. The device for managing heterogeneous distributed cloud resources of claim 7, wherein the device further comprises:
a metering and billing portion, which is configured to determine, according to the order of the user, cost of the cloud product ordered by the user and amount of cloud resources occupied by the cloud product ordered by the user.

9. The device for managing heterogeneous distributed cloud resources of claim 7, wherein
the automated layout portion is configured to access the determined heterogeneous distributed cloud resources corresponding to the cloud product ordered by the user via an application programming interface and create the cloud product ordered by the user.

10. The device for managing heterogeneous distributed cloud resources of claim 7, wherein the device further comprises:
a user management portion, which is configured to manage the user in the form of a tenant.

11. an apparatus, comprising:
at least one processor; and
a memory, which is configured to store instructions,
wherein when the instructions executed by the at least one processor, the at least one processor performs a method comprising steps of:
accessing heterogeneous distributed cloud resources;
creating a correspondence between cloud products and the heterogeneous distributed cloud resources, and publishing information of the cloud products;
receiving an order of a user for a cloud product;
determining heterogeneous distributed cloud resources corresponding to the cloud product ordered by the user according to the order of the user by using the correspondence between the cloud products and the heterogeneous distributed cloud resources; and
accessing the determined heterogeneous distributed cloud resources corresponding to the cloud product ordered by the user, and creating the cloud product ordered by the user.

12. The apparatus of claim 11, wherein
the step of publishing information of the cloud products comprises publishing price of the cloud products.

13. The apparatus of claim 12, wherein after the step of receiving an order of a user for a cloud product, the at least one processor further performs step of:
determining, according to the order of the user, cost of the cloud product ordered by the user and amount of cloud resources occupied by the cloud product ordered by the user.

14. The apparatus of claim 11, wherein the step of accessing the heterogeneous distributed cloud resources corresponding to the cloud product ordered by the user and creating the cloud product ordered by the user comprises step of:
accessing the determined heterogeneous distributed cloud resources corresponding to the cloud product ordered by the user via an application programming interface and creating the cloud product ordered by the user.

15. The apparatus of claim 11, wherein the cloud products comprise:
a cloud hosting service and/or a cloud storage service.

16. The apparatus of claim 11, wherein the heterogeneous distributed cloud resources comprise:
an X86 physical machine and/or a public cloud.

17. A computer-readable storage medium storing instructions, wherein when the instructions are executed by a processor, the processor performs the method for managing heterogeneous distributed cloud resources of claim 1.

18. The computer-readable storage medium of claim 17, wherein
the step of publishing information of the cloud products comprises publishing price of the cloud products.

19. The computer-readable storage medium of claim 17, wherein after the step of receiving an order of a user for a cloud product, the processor further performs step of:
determining, according to the order of the user, cost of the cloud product ordered by the user and amount of cloud resources occupied by the cloud product ordered by the user.

20. The computer-readable storage medium of claim 17, wherein the step of accessing the heterogeneous distributed cloud resources corresponding to the cloud product ordered by the user and creating the cloud product ordered by the user comprises:
accessing the determined heterogeneous distributed cloud resources corresponding to the cloud product ordered by the user via an application programming interface and creating the cloud product ordered by the user.
